(19) United States
(12) Patent Application Publication
(10) Pub. No.: US 2009/0057339 A1
(43) Pub. Date: Mar. 5, 2009

(54) Child-Resistant Closure for Bag-in-Box Dispenser

(76) Inventors: Elizabeth N. Piscotty, Livermore, CA (US); Michael J. Hall, South San Francisco, CA (US); Timothy James Kennedy, Pleasanton, CA (US); Valeria Garino, Buenos Aires (AR); Adriana Graciela Cortese, Buenos Aires (AR); Virginia Silvia Gines, Buenos Aires (AR); Hernan Leandro Braberman, Buenos Aires (AR)

Correspondence Address: THE CLOROX COMPANY, P.O. BOX 24305, OAKLAND, CA, 94623-1305, US

(21) Appl. No.: 11/845,936

(22) Filed: Aug. 28, 2007

(51) Int. Cl. B65D 35/56; B67B 5/00

(52) U.S. Cl. 222/105; 222/153.14

(57) ABSTRACT

A bag-in-box dispenser has a child-resistant closure to prevent unintentional opening of the valve lever. The child resistant closure works with a finger-activated unlocking means on the dispensing spigot or fitment. The dispenser optionally includes a cup to receive the liquid. The valve housing and lever housing can snap together to form a leak-proof seal.

### BACKGROUND OF THE INVENTION

1. Field of the Invention

This invention relates generally to bag-in-box dispensers having a child-resistant closure.

2. Description of the Related Art

Distribution and sale of liquid products in flexible plastic bags supported in corrugated cardboard boxes has enjoyed great commercial success. Such products as water, wine, syrups for reconstituting soft drinks and the like are shipped in these containers and dispensed directly from the containers at the point of use. In order to facilitate dispensing the liquid products, dispensing valves or taps are inserted into the plastic container to permit draining the contents by gravity. Such valves are made largely of plastic for reasons of economy and are discarded or recycled together with the liquid-containing bag. The valves are often made to be self-closing both for convenience and to prevent accidental spillage of the container contents from a tap that is not closed properly. Self-closing valves for service in flexible bag distribution of liquids typically have a valve housing through which the liquid flows from the bag to the outside, and a valve orifice within the valve housing which can be selectively obstructed by a valve member. A spring typically biases the valve member toward the closed position, and some means is provided for opening the valve by exerting a force on an external member to force the valve element away from its closed position to permit the liquid to flow out through the valve orifice.

Bag-in-box dispensers have been developed to deliver a variety of liquid products because these dispensers provide cheaper and lighter packaging compared to convention plastic containers. Most of these dispensers have been used in industrial and institutional settings where bulk storage is more common. U.S. Pat. No. 3,964,636 to Rehrig describes a box with a hinged lid encasing a removable plastic bag with a capped dispensing outlet. U.S. Pat. No. 4,355,737 to Pongrass et al. describes a fluid containing plastic bag stored within a box with a rotatable turncock barrel dispensing closure. U.S. Pat. No. 4,515,294 to Udall describes a bag-in-box with a depressible plunger dispenser. PCT Appl. WO 83/04082 to Welsh et al. describes a bag-in-box dispenser with a elastomeric diaphragm and pull-tab closure. U.S. Pat. No. 5,085,346 to Wright describes a bag-in-box package with a dispensing spigot. None of these bag-in-box dispensers describe a child-resistant-closure mechanism that may be required when these dispensers are used by typical consumers who have children.

To overcome these problems of prior art bag-in-box dispensers, dispensers of the present invention are designed for convenience and safety in a consumer home environment.

### BRIEF DESCRIPTION OF THE DRAWINGS

The foregoing aspects and others will be readily appreciated by the skilled artisan from the following description of illustrative embodiments when read in conjunction with the accompanying drawings, wherein:

FIG. 1 is a perspective view of one embodiment of the invention;

FIG. 2 is a cross-sectional view one embodiment of the invention;

FIG. 3 is a perspective view of one embodiment of the invention;

FIG. 4 is a perspective view of one embodiment of the invention;

FIG. 5 is a perspective view of one embodiment of the invention.

FIG. 6 is a cross-sectional view one embodiment of the invention;

FIG. 7 is a cross-sectional view one embodiment of the invention;

FIG. 8 is a perspective view of one embodiment of the invention;

FIG. 9 is a side view of one embodiment of the invention; and

FIG. 10 is a cross-sectional view of one embodiment of the invention; and

FIG. 11 is a perspective view of one embodiment of the invention;

Reference will now be made to the drawings wherein like numerals refer to like parts throughout. As used herein, positional terms, such as “bottom” and “top” and the like, and directional terms, such as “up”, “down” and the like, are employed for ease of description in conjunction with the drawings. Further, the terms “interior”, “inwardly” and the like, refer to positions and directions toward the geometric center of embodiments of the present invention and designated parts thereof. The terms “exterior”, “outwardly”, and the like, refer to positions and directions away from the geometric center. None of these terms is meant to indicate that the described components must have a specific orientation except when specifically set forth.

Figures illustrating the components of this invention and the container show some conventional mechanical elements that are known and that will be recognized by one skilled in the art. The detailed descriptions of such elements are not necessary to an understanding of the invention, and accordingly, are herein presented only to the degree necessary to facilitate an understanding of the novel features of the present invention.

### SUMMARY OF THE INVENTION

In accordance with the above objects and those that will be mentioned and will become apparent below, one aspect of the present invention comprises a bag-in-box dispenser comprising: a paperboard container having a top surface, a bottom surface, a plurality of side surfaces, and an interior portion containing a collapsible container for use in containing and dispensing a liquid; and a spigot extendable through the paperboard container and fluidly attached to the collapsible container; the spigot having a valve housing and a lever housing; wherein the valve housing has a finger activated unlocking means; wherein the lever housing has an operating lever with an open and closed position for controlling the fluid flow by rotating the operating lever relative to the valve housing; and wherein the finger activated unlocking means prevents rotating the operating lever without activating the finger activated unlocking means.

In accordance with the above objects and those that will be mentioned and will become apparent below, another aspect of the present invention comprises a bag-in-box packaging system comprising: a paperboard box having sidewalls defining an interior chamber; and a flexible polymeric container positioned within the chamber, the container having sidewalls sealed together to define a fluid chamber therebetween, the container having a dispensing fitment attached to a sidewall, the fitment having a valve housing and a lever housing wherein the valve housing has a finger activated unlocking means; wherein the lever housing has an operating lever with an open and closed position for controlling the fluid flow by rotating the operating lever relative to the valve housing; and wherein the finger activated unlocking means prevents rotating the operating lever without activating the finger activated unlocking means.

In accordance with the above objects and those that will be mentioned and will become apparent below, another aspect of the present invention comprises a liquid container for containing a liquid therein which comprises an outer box having at least one flat wall; a flexible inner bag accommodated in the outer box; a spigot fixed to the inner bag so as to be projected outwardly of the flat wall of the outer box; and the spigot having a valve housing and a lever housing wherein the valve housing has a finger activated unlocking means; wherein the lever housing has an operating lever with an open and closed position for controlling the fluid flow by moving the operating lever relative to the valve housing; and wherein the finger activated unlocking means prevents moving the operating lever without activating the finger activated unlocking means.

### DETAILED DESCRIPTION OF THE INVENTION

Before describing the present invention in detail, it is to be understood that this invention is not limited to particularly exemplified systems that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference. The citation of any document is not to be construed as an admission that it is prior art with respect to the present invention.

As used herein, forms of the words “comprise”, “have”, and “include” are legally equivalent and open-ended and do not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

The term “plastic” is defined herein as any polymeric material that is capable of being shaped or molded, with or without the application of heat. Usually plastics are a homo-polymers or co-polymers of high molecular weight. Plastics fitting this definition include, but are not limited to, polyolefins, polyesters, nylon, vinyl, acrylic, polycarbonates, polystyrene, and polyurethane.

### Dispensing System

The dispensing system for the bag-in-box dispenser can replace existing heavier warehouse club packaging for liquid cleaning products. The dispensing system can consist of two distinct parts: a bag-in-box with a valve assembly to control the gravity-fed flow of liquid out of the bag and to ensure a tight, leak free seal; and a vessel or other method to transport the product from the package to the washer, bucket or other cleaning location. The cup or vessel can be stored on top of the valve. This dispensing system can be applicable to “pour” type products, products that are typically poured from a bottle directly into a washer, bucket or other location, and “spray” products, wherein the dispensing system will be used to refill a spray bottle. The dispensing system can be sold together as a bag-in-box and a cup or spray bottle.

### Bag-in-Box

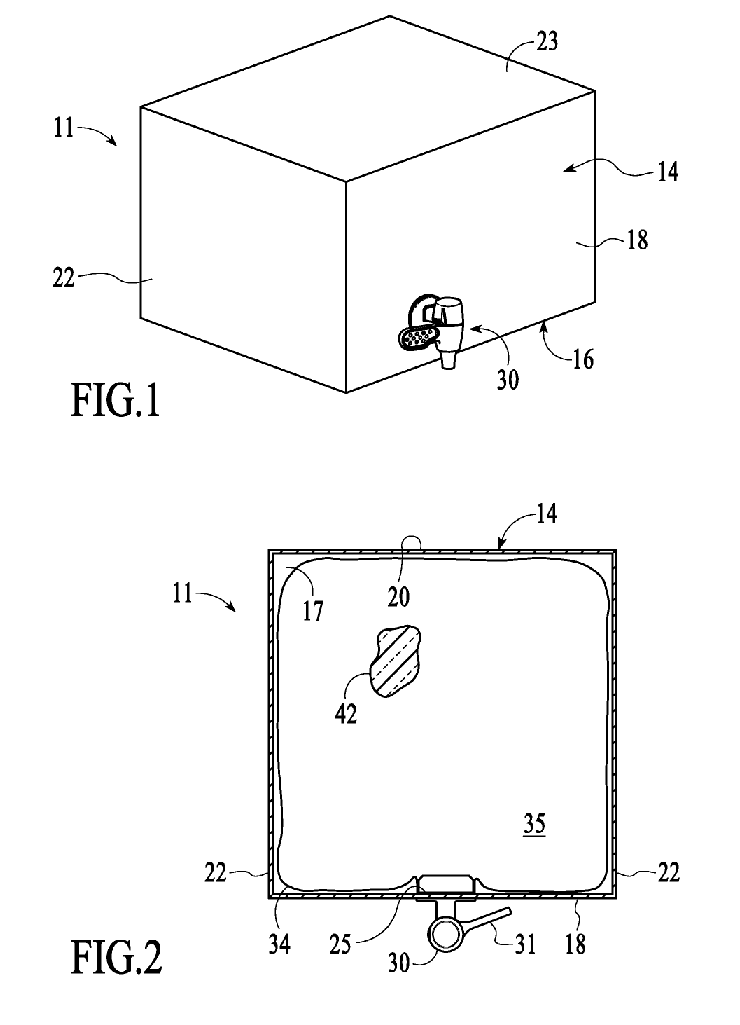

Referring to FIGS. 1 and 2, one embodiment of the dispenser 11 comprises a carton 14 having a bottom surface 16, a face panel 18, a rear panel 20, a pair of side panels 22 and a top surface 23. According to one embodiment, carton 14 is formed from rigid sheet material, for example cardboard or paperboard and has a substantially flat bottom surface 16 for allowing carton 14 to be self-supported. Carton 14 is preferably formed from non-permeable sheet material, or otherwise rendered moisture-resistant, such as, for example, by the application of a laminate or a plastic shrink wrap. Carton 14 is suitably closed and permanently sealed, enclosing an internal cavity 17. A collapsible container 34 is positioned within internal cavity 17, a portion of collapsible container 34 being adjacent passageway 25. Collapsible container 34 is suitably formed from non-permeable flexible sheet material and permanently sealed, forming a reservoir for the storage and dispensing of fluids 42. Collapsible container 34 is provided with a selectively operable, fluid dispensing spigot 30 for dispensing fluid 42 contained within the interior 35 of collapsible container 34.

### Valve System

The valve system suitably fits with commercially available bag-in-box connectors or fitments. The child-resistant closure suitably contains an element that virtually eliminates the chance that a child can access the product, for example bleach.

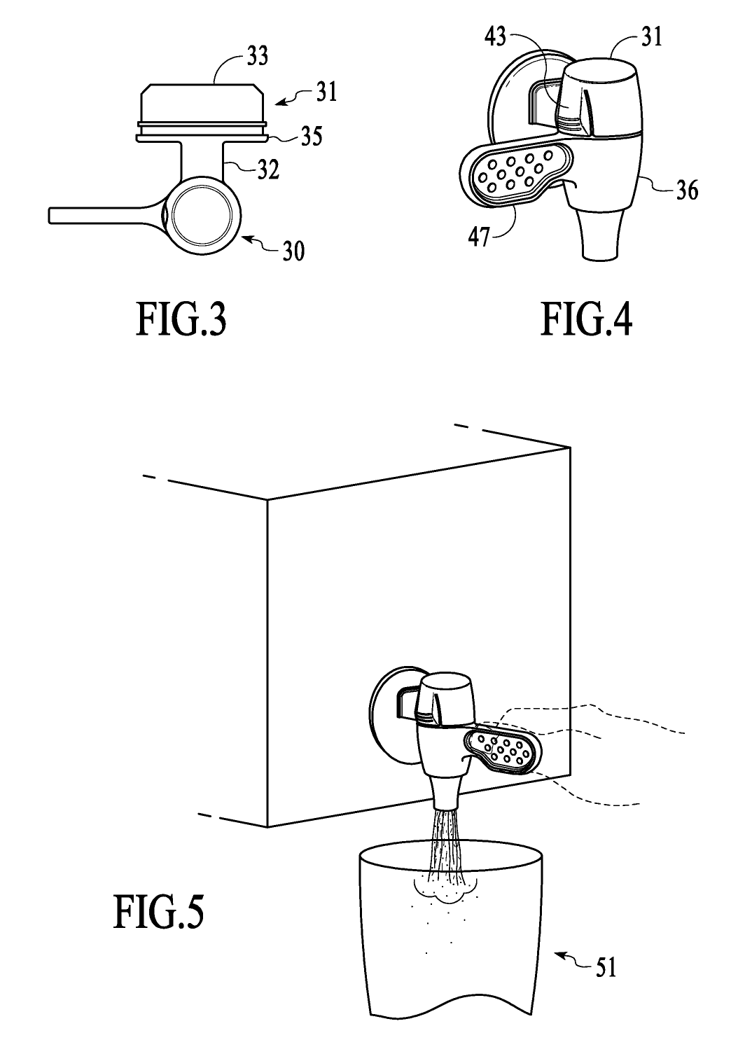

In one embodiment, the dispensing fitment or spigot 30 of FIGS. 1-5 comprises a valve housing 31 having a valve body 32 bearing a rim 33 for attaching the valve housing 31 to a liquid container such as a collapsible container 34. A flange 35 surrounding the valve body 32 provides strength and may help to position (and lock) the valve 30 within a carton 14 surrounding the liquid-containing collapsible container 34.

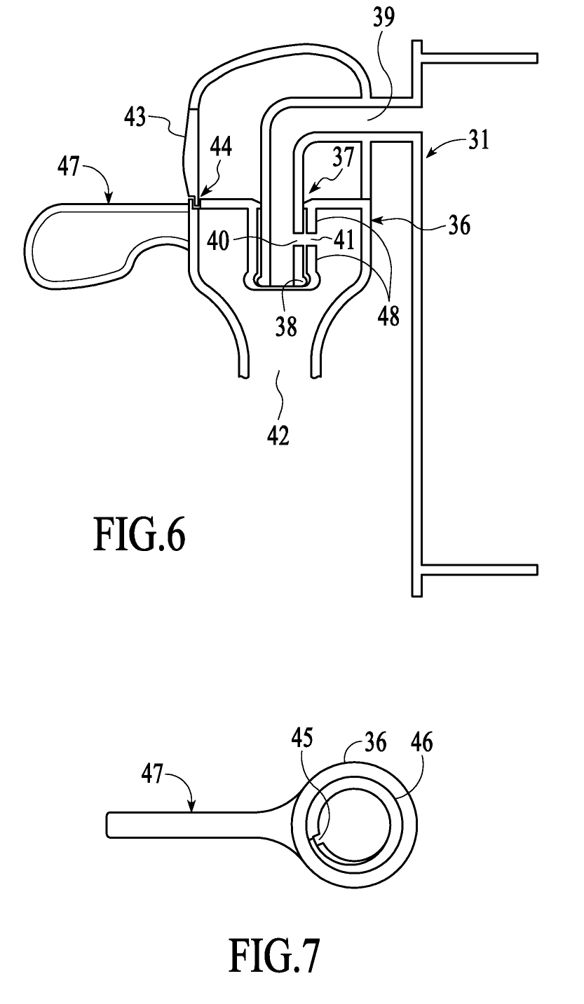

In the section view, FIG. 6, the valve housing 31 and the lever housing 36 snap together with a sealing means 37 and a snap means 38 to attach the valve housing 31 to the lever housing 36. The fluid flows through the inner tube 39. As the lever housing 36 is rotated, a hole in the lever housing 40 lines up with a hole in the valve housing 41, and fluid can flow out the lever housing port 42. A raised seal 48 on the inner portion of the valve housing 31 surrounding the hole in the valve housing 41 prevents fluid flow unless the holes 40 and 41 are at least partially overlapped. The raised seal can also be on the outer portion of the lever housing surrounding the hole in the lever housing (not shown). The valve housing 35 contains a moveable section or finger activated unlocking means 43 which can be pressed in (or squeezed) to move a hook 44 out of a notch 45 in a locking ring 46 (FIG.7) on the valve housing 35 allowing the lever 47 and the lever housing 36 to be rotated. In the closed position, the hook 44 is aligned with the notch 45.

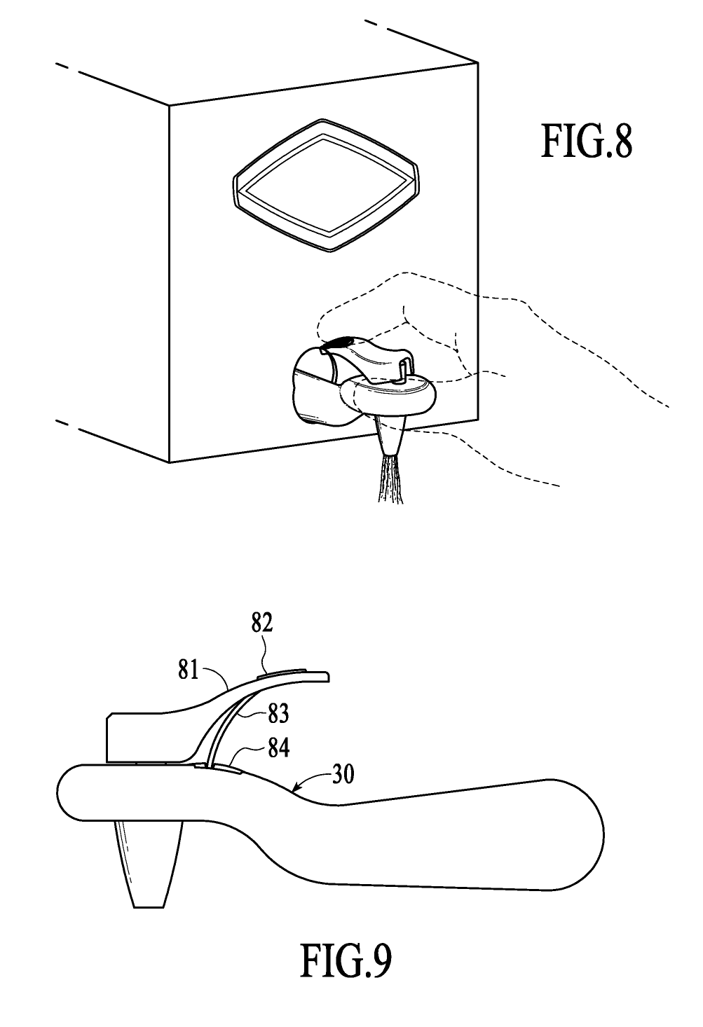

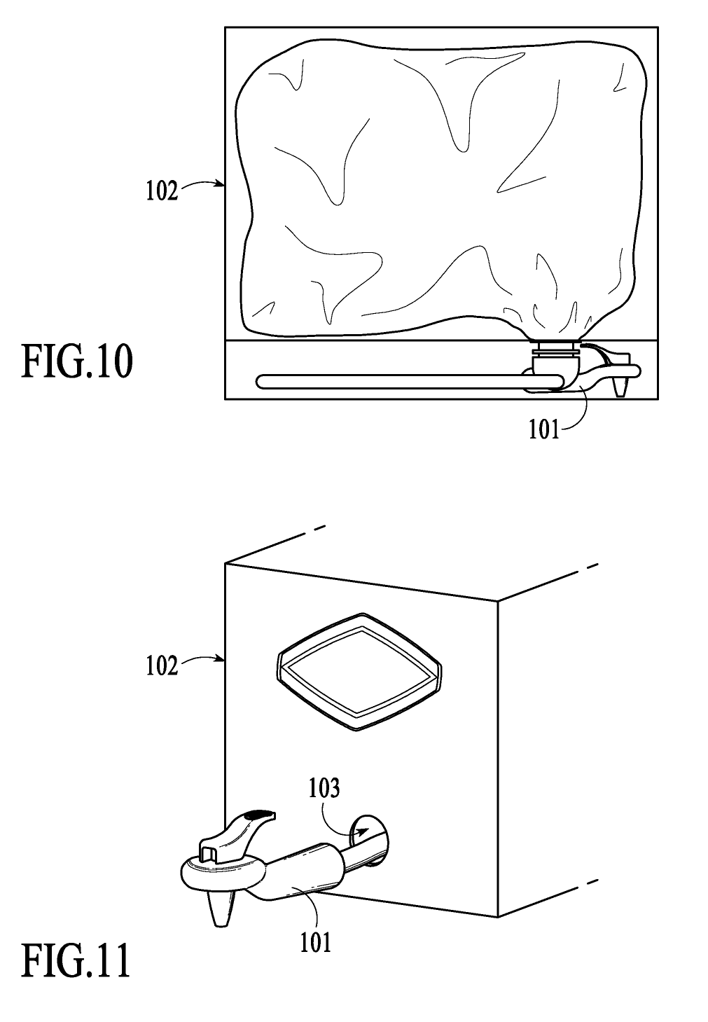

In another embodiment (FIG. 8-9), the spigot 30 works by a push lever 81 mechanism having a sliding button 82 and an unlocking hook 83 secured in a notch 84. In one embodiment, the dispensing spigot 101 (spout, fitment, valve housing) is extendable from a first, shipping position (FIG. 10), wherein it is retracted to a position within the paperboard container 102, through an access door 103 to a second, dispensing position (FIG. 11), wherein the dispensing spigot 101 is extended through the paperboard container 102. The access door 103 can be moveable or removeable through a perforated section, wherein the open access door 103 is dimensioned to receive the spigot or fitment. Alternate spigot designs, such as spigot 30, can also be stored within the paperboard container during shipment or when not in use and extended during use. In one embodiment, the cup/vessel 51 (FIG. 5) can hold at least 10 fl oz of liquid and can attach to valve in one motion using one hand, for example by snap, bayonet, etc. The hole in the box for the bag connector can be centered horizontally and can be no more than 1.5″ from bottom of box. In one embodiment, the valve/cup assembly can ship fully assembled and enclosed within the box, having width of approximately 8.5″, depth of approximately 13″, and height of approximately 11.″

The valve system can connect to a bag using a 28 mm barbed connector to fit existing 28 mm bag-in-box bag connectors or fitments. The valve system can be a self-closing valve, for example using a spring, and can deliver controllable flow rates of in a range between 0.5 and 3 gal/min, or up to 5 gal/min. The flow control can be continuous or with discrete flow levels.

While this detailed description includes specific examples according to the invention, those skilled in the art will appreciate that there are many variations of these examples that would nevertheless fall within the general scope of the invention and for which protection is sought in the appended claims.

What is claimed is:

1. A bag-in-box dispenser comprising:
a. a paperboard container having a top surface, a bottom surface, a plurality of side surfaces, and an interior portion containing a collapsible container for use in containing and dispensing a liquid; and
b. a spigot extendable through the paperboard container and fluidly attached to the collapsible container;
c. the spigot having a valve housing and a lever housing;
d. wherein the valve housing has a finger activated unlocking means;
e. wherein the lever housing has an operating lever with an open and closed position for controlling the fluid flow by rotating the operating lever relative to the valve housing; and
f. wherein the finger activated unlocking means prevents rotating the operating lever without activating the finger activated unlocking means.

2. The dispenser of claim 1, wherein the unlocking means has a hook and the lever housing has a locking ring with a notch that aligns with the hook when the operating lever is in the closed position.

3. The dispenser of claim 1, wherein the spigot is extendable from a first, shipping position, wherein it is retracted to a position within the paperboard container to a second, dispensing position, wherein it is extended through the paperboard container.

4. The dispenser of claim 1, wherein the valve housing and the lever housing snap together with a sealing means and a snap means to attach the valve housing to the lever housing.

5. The dispenser of claim 1, wherein a raised seal on the inner portion of the valve housing and surrounding a hole in the valve housing prevents fluid flow unless the hole in the valve housing and a hole in the lever housing are at least partially overlapped.

6. The dispenser of claim 1, wherein a raised seal on the outer portion of the lever housing and surrounding a hole in the lever housing prevents fluid flow unless the hole in the valve housing and a hole in the lever housing are at least partially overlapped.

7. A bag-in-box packaging system comprising:
a paperboard box having sidewalls defining an interior chamber; and a flexible polymeric container positioned within the chamber, the container having sidewalls sealed together to define a fluid chamber therebetween, the container having a dispensing fitment attached to a sidewall, the fitment having a valve housing and a lever housing wherein the valve housing has a finger activated unlocking means; wherein the lever housing has an operating lever with an open and closed position for controlling the fluid flow by rotating the operating lever relative to the valve housing; and wherein the finger activated unlocking means prevents rotating the operating lever without activating the finger activated unlocking means.

8. The system of claim 7 wherein the box has an access door that is moveable from a closed position to an open position and is dimensioned to receive the fitment.

9. The dispenser of claim 7, wherein the unlocking means has a hook and the lever housing has a locking ring with a notch that aligns with the hook when the operating lever is in the closed position.

10. The dispenser of claim 7, wherein the dispensing fitment is extendable from a first, shipping position, wherein it is retracted to a position within the paperboard container to a second, dispensing position, wherein it is extended through the paperboard container.

11. The dispenser of claim 7, wherein the valve housing and the lever housing snap together with a sealing means and a snap means to attach the valve housing to the lever housing.

12. The dispenser of claim 7, wherein a raised seal on the inner portion of the valve housing and surrounding a hole in the valve housing prevents fluid flow unless the hole in the valve housing and a hole in the lever housing are at least partially overlapped.

13. The dispenser of claim 7, wherein a raised seal on the outer portion of the lever housing and surrounding a hole in the lever housing prevents fluid flow unless the hole in the valve housing and a hole in the lever housing are at least partially overlapped.

14. A liquid container for containing a liquid therein which comprises an outer box having at least one flat wall; a flexible inner bag accommodated in the outer box; a spigot fixed to the inner bag so as to be projected outwardly of the flat wall of the outer box; and the spigot having a valve housing and a lever housing wherein the valve housing has a finger activated unlocking means; wherein the lever housing has an operating lever with an open and closed position for controlling the fluid flow by moving the operating lever relative to the valve housing; and wherein the finger activated unlocking means prevents moving the operating lever without activating the finger activated unlocking means.

15. The container of claim 14, wherein the outer box is paperboard.

16. The container of claim 14, wherein the unlocking means has a hook and the lever housing has a locking ring with a notch that aligns with the hook when the operating lever is in the closed position.

17. The container of claim 14, wherein the spigot is extendable from a first, shipping position, wherein it is retracted to a position within the paperboard container to a second, dispensing position, wherein it is extended through the paperboard container.

18. The container of claim 14, wherein the valve housing and the lever housing snap together with a sealing means and a snap means to attach the valve housing to the lever housing.

19. The container of claim 14, wherein a raised seal on the inner portion of the valve housing and surrounding a hole in the valve housing prevents fluid flow unless the hole in the valve housing and a hole in the lever housing are at least partially overlapped.

20. The dispenser of claim 14, wherein a raised seal on the outer portion of the lever housing and surrounding a hole in the lever housing prevents fluid flow unless the hole in the valve housing and a hole in the lever housing are at least partially overlapped.
